(19) United States
(12) Patent Application Publication
(10) Pub. No.: US 2020/0318778 A1
(43) Pub. Date: Oct. 8, 2020

(54) DRIVING DEVICE, GIMBAL, PHOTOGRAPHING DEVICE AND UNMANNED AERIAL VEHICLE

(71) Applicant: SZ DJI TECHNOLOGY CO., LTD., Shenzhen (CN)

(72) Inventors: Yucheng LIU, Shenzhen (CN); Li QIU, Shenzhen (CN)

(21) Appl. No.: 16/910,984

(22) Filed: Jun. 24, 2020

Related U.S. Application Data
(63) Continuation of application No. PCT/CN2017/119907, filed on Dec. 29, 2017.

(51) Int. Cl. F16M 11/12; G03B 15/00; G03B 17/56; F16M 11/18; B64C 39/02; B64D 47/08

(52) U.S. Cl. CPC F16M 11/12; G03B 15/006; G03B 17/561; B64C 2201/127; B64C 39/024; B64D 47/08; B64C 2201/027; F16M 11/18

(57) ABSTRACT

A device for driving a gimbal includes a first base, a second base, and a driver disposed at the first base and the second base. The first base includes a first side wall enclosing a first accommodation space. The second base includes a second side wall enclosing a second accommodation space. The first accommodation space and the second accommodation space form an accommodation cavity. The first side wall and the second side wall are disposed opposite to each other and form a gap in communication with the accommodation cavity. A part of the second side wall extends into the first accommodation space and separate the gap from the accommodation cavity. The driver is accommodated in the accommodation cavity and configured to drive the second base to rotate relative to the first base.

### CROSS-REFERENCE TO RELATED APPLICATION

This application is a continuation of International Application No. PCT/CN2017/119907, filed Dec. 29, 2017, the entire content of which is incorporated herein by reference.

### TECHNICAL FIELD

The present disclosure relates to the driving device technology field, and more particularly, to a driving device, a gimbal, a photographing device, and an unmanned aerial vehicle.

### BACKGROUND

In existing technologies, a driving device generally has a gap between a stator assembly and a rotor assembly that rotate relative to each other, to avoid an interference therebetween during rotation. However, dust and moisture outside the driving device can easily enter the driving device along the gap, thereby causing contamination or damage to an inside of the driving device and affecting the rotation of the rotor assembly relative to the stator assembly.

### SUMMARY

In accordance with the disclosure, there is provided a device for driving a gimbal including a first base, a second base, and a driver disposed at the first base and the second base. The first base includes a first side wall enclosing a first accommodation space. The second base includes a second side wall enclosing a second accommodation space. The first accommodation space and the second accommodation space form an accommodation cavity. The first side wall and the second side wall are disposed opposite to each other and form a gap in communication with the accommodation cavity. A part of the second side wall extends into the first accommodation space and separate the gap from the accommodation cavity. The driver is accommodated in the accommodation cavity and configured to drive the second base to rotate relative to the first base.

Also in accordance with the disclosure, there is provided a gimbal including a driving device. The driving device includes a first base, a second base, and a driver disposed at the first base and the second base. The first base includes a first side wall enclosing a first accommodation space. The second base includes a second side wall enclosing a second accommodation space. The first accommodation space and the second accommodation space form an accommodation cavity. The first side wall and the second side wall are disposed opposite to each other and form a gap in communication with the accommodation cavity. A part of the second side wall extends into the first accommodation space and separate the gap from the accommodation cavity. The driver is accommodated in the accommodation cavity and configured to drive the second base to rotate relative to the first base.

Also in accordance with the disclosure, there is provided a photographing device including a gimbal and an imaging device disposed at the gimbal. The gimbal includes a driving device. The driving device includes a first base, a second base, and a driver disposed at the first base and the second base. The first base includes a first side wall enclosing a first accommodation space. The second base includes a second side wall enclosing a second accommodation space. The first accommodation space and the second accommodation space form an accommodation cavity. The first side wall and the second side wall are disposed opposite to each other and form a gap in communication with the accommodation cavity. A part of the second side wall extends into the first accommodation space and separate the gap from the accommodation cavity. The driver is accommodated in the accommodation cavity and configured to drive the second base to rotate relative to the first base.

Also in accordance with the disclosure, there is provided an unmanned aerial vehicle including a body and the above photographing device disposed at the body.

### BRIEF DESCRIPTION OF THE DRAWINGS

FIG. 1 is a schematic three-dimensional structural diagram of a photographing device according to one embodiment of the present disclosure.

FIG. 2 is a schematic two-dimensional structural diagram of a photographing device according to another embodiment of the present disclosure.

FIG. 3 is a cross-sectional diagram of the photographing device along in FIG. 2.

FIG. 4 is an enlarged view of part IV of the photographing device in FIG. 3.

FIG. 5 is an enlarged view of part V of the photographing device in FIG. 3.

FIG. 6 is an enlarged view of part VI of the photographing device in FIG. 3.

FIG. 7 is a cross-sectional diagram of the photographing device along VII-VII in FIG. 2.

FIG. 8 is an enlarged view of part VIII of the photographing device in FIG. 7.

FIG. 9 is a schematic diagram of a three-dimensional structure of an unmanned aerial vehicle according to one embodiment of the present disclosure.

### DETAILED DESCRIPTION OF THE EMBODIMENTS

Technical solutions of the present disclosure will be described in detail with reference to the drawings. Same or similar labels indicate same or similar elements or elements with same or similar functions. The embodiments described below with reference to the drawings are illustrative and only for explanation purposes, and should not be constructed as limiting the present disclosure.

It should be noted that orientations or positional relationships indicated by terms “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” etc. are based on the orientations or positional relationships shown in the drawings, and are only for the convenience of describing the disclosure and simplifying the description, rather than indicating or implying that a device or an element referred to must have a specific orientation or must be constructed and operated in a specific orientation, and therefore should not be understood as a limitation to the present disclosure. In addition, terms “first” and “second” are only for descriptive purposes and should not be understood as indicating or implying a relative importance or implicitly indicating the number of a technical feature indicated. A feature defined as “first” and “second” may explicitly or implicitly include one or more of the feature. In the description of the present disclosure, the term “plurality” refers to two or more, unless otherwise specifically defined.

It should be noted that, unless otherwise clearly specified and defined, terms “dispose,” “combine,” “connect,” and “connection” should be understood in a broad sense. For example, they can indicate a fixed connection, a detachable connection, or an integral connection. They can indicate a mechanical connection, an electrical connection, or being able to communicate with each other. They can indicate a direct connection or an indirect connection through an intermediary. Then can indicate a connection between two components or an interaction between two components. For those having ordinary skills in the art, specific indications of the terms in the present disclosure can be understood according to specific situations.

In the present disclosure, unless otherwise clearly specified and defined, a first feature being “above” or “below” a second feature may include a direct contact of the first and second features, or may include no direct contact but a contact through other features in between. Further, the first feature being “above” the second feature includes that the first feature is directly above or obliquely above the second feature, or only indicates that the first feature is higher in level than the second feature. The first feature being “below” the second feature includes that the first feature is directly below or obliquely below the second feature, or only indicates that the first feature is lower in level than the second feature.

This specification provides many different embodiments or examples for realizing different structures of the present disclosure. In order to simplify the description of the present disclosure, components and settings of specific examples are described below. They are merely examples and are not intended to limit the disclosure. In addition, the present disclosure may repeat a reference number and/or a reference letter in different examples for a purpose of simplification and clarity, which does not indicate a relationship between embodiments and settings described. Other embodiments conceived by those having ordinary skills in the art on the basis of the described embodiments without inventive efforts should fall within the scope of the present disclosure.

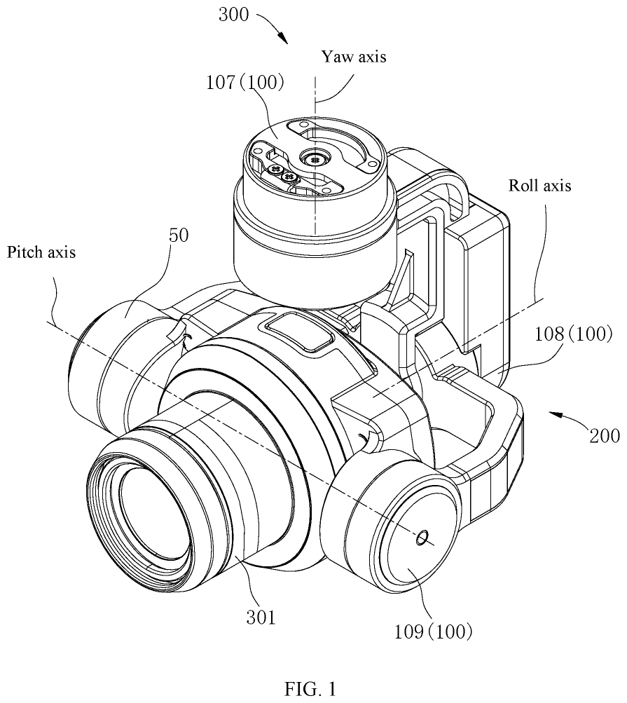

As shown in FIGS. 1-4, a driving device 100 of a gimbal 200 includes a first base 10, a second base 20, and a driver 30. The first base 10 includes a first side wall 11 that encloses a first accommodation space 12. The second base 20 includes a second side wall 21 that encloses a second accommodation space 22. The first base 10 and the second base 20 are combined. The first accommodation space 12 and the second accommodation space 22 form an accommodation cavity 101. The first side wall 11 and the second side wall 21 are disposed opposite to each other and form a gap 102 that allows a relative rotation. The gap 102 is in communication with the accommodation cavity 101. Part of the structure of the second side wall 21 extends into the first accommodation space 12 and separates the gap 102 from the accommodation cavity 101. The driver 30 is disposed at the first base 10 and the second base 20, and is accommodated in the accommodation cavity 101. The driver 30 is configured to drive the second base 20 to rotate relative to the first base 10.

In some embodiments, the gimbal 200 may be a single-axis gimbal, a dual-axis gimbal, a three-axis gimbal, or any multi-axis gimbal. The driving device 100 is a motor. The first base 10 and the second base 20 can be casings of an axis arm of the gimbal 200; or, the first base 10 and the second base 20 can be casings of an adapter of the gimbal 200. The first base 10 and the second base 20 are connected together by the driver 30. The driver 30 includes a stator 31 and a rotor 32 that are rotatably connected together. In some embodiments, the stator 31 is fixed at the first base 10 and the rotor 32 is fixed at the second base 20, and when the rotor 32 rotates relative to the stator 31, the rotor 32 drives the second base 20 to rotate relative to the first base 10. In some other embodiments, the stator 31 is fixed at the second base 20 and the rotor 32 is fixed at the first base 10, and when the rotor 32 rotates relative to the stator 31, the rotor 32 drives the first base 10 to rotate relative to the second base 20. When the first base 10 and the second base 20 are combined, part of the structure of the second side wall 21 extends into the first accommodation space 12, at least part of the first side wall 11 surrounds the second side wall 21, and the first side wall 11 (or the second side wall 21) can shield the gap 102 formed by a relative spacing between a first end surface 117 of the first side wall 11 (i.e., the end surface surrounding one end of the second side wall 21) and a second end surface 217 of the second side wall 21 (i.e., the end surface accommodated in one end of the first accommodation space 12).

In some embodiments, part of the structure of the second side wall 21 extends into the first accommodation space 12 and separates the gap 102 from the accommodation cavity 101, thereby increasing a difficulty of dust, moisture, etc. entering the accommodation cavity 101 along the gap 102, and hence improving a protective capability, e.g., dustproof and waterproof, etc., of the driving device 100 and ensuring a normal rotation of the driving device 100.

As shown in FIGS. 1-4, the driving device 100 of the gimbal 200 includes the first base 10, the second base 20, and the driver 30.

The first base 10 includes a cover 13 and a connection base 14. The connection base 14 includes a first bottom wall 141 and a first side wall 11 extending from the first bottom wall 141. The cover 13 is fixed at the side of the first bottom wall 141 opposite to the first side wall 11. The cover 13, the first bottom wall 141, and the first side wall 11 together form the first accommodation space 12. The first side wall 11 may be a ring structure. In some embodiments, the first bottom wall 141 encloses the end of the first side wall 11 close to the cover 13, and the first bottom wall 141 and the first side wall 11 together form the first accommodation space 12. In some embodiments, the cover 13 and the connection base 14 are an integral structure.

The second base 20 includes a second bottom wall 25 and a second side wall 21 extending from the second bottom wall 25. The second bottom wall 25 and the second side wall 21 together form the second accommodation space 22. The second side wall 21 may be a ring structure. An outer surface 210 of the second side wall 21 has an outer accommodation groove 211 surrounding the second accommodation space 22 to form an annular protrusion 212, that is, a second end surface 217 of the second side wall 21 (i.e., the end of the second side wall 21 away from the second bottom wall 25) extends toward the first base 10 to form the annular protrusion 212, and the annular protrusion 212 and the second end surface 217 together form an outer accommodation groove 211. The second base 20 is rotatably combined with the first base 10. When the second base 20 is combined with the first base 10, the annular protrusion 212 extends into the first accommodation space 12, and part of the first sidewall 11 extends into the outer accommodation groove 211. A first end surface 117 of the first side wall 11 (i.e., the end of the first side wall 11 away from the first bottom wall 141) is spaced from the second end surface 217 to form a gap 102. The annular protrusion 212 is spaced from the first side wall 11 to form a gap 103. The annular protrusion 212 separates the gap 102 from the accommodation cavity 101. The gap 102 is connected to the gap 103 to form a bent channel 104, which indicates that a straight line cannot pass through the gap 102 and the gap 103. The annular protrusion 212 separates the gap 102 from the accommodation cavity 101, thereby increasing a difficulty of dust, moisture, etc. entering the accommodation cavity 101 along the gap 102, and hence improving a protective capability, e.g., dustproof and waterproof, etc., of the driving device 100.

The driver 30 includes a stator 31 and a rotor 32. The stator 31 is disposed at the first bottom wall 141, and the rotor 32 is disposed at the second bottom wall 25. The stator 31 and the rotor 32 can be rotatably connected together. When the rotor 32 rotates relative to the stator 31, the rotor 32 drives the second base 20 to rotate relative to the first base 10.

In some embodiments, the gimbal 200 is a three-axis gimbal, and the driving device 100 can be a yaw driving device provided at a yaw axis, a roll driving device provided at a roll axis, or a pitch driving device provided at a pitch axis. In some embodiments, the driving device 100 is a roll driving device, in which case the first base 10 is a casing of an arm of the yaw axis, and the second base 20 is a casing of an arm of the roll axis.

In some embodiments, part of the structure of the second side wall 21 of the driving device 100 of the gimbal 200 (i.e., the annular protrusion 212) extends into the first accommodation space 12 and separates the gap 102 from the accommodation cavity 101, thereby increasing a difficulty of dust, moisture, etc. entering the accommodation cavity 101 along the gap 102, and hence improving a protective capability, e.g., dustproof and waterproof, etc., of the driving device 100 and ensuring a normal rotation of the driving device 100.

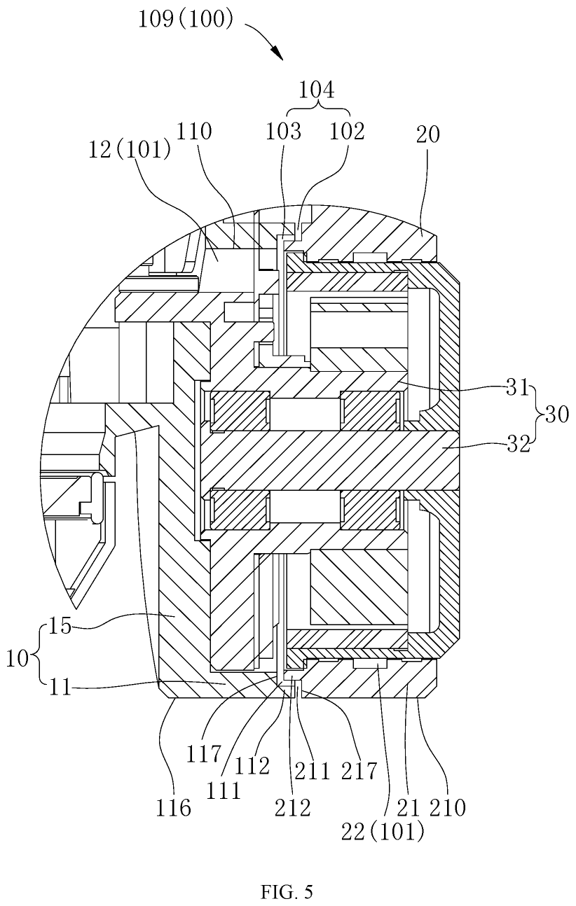

In some embodiments, as shown in FIG. 5, an inner surface 110 of the first side wall 11 has an inner accommodation groove 111 surrounding the first accommodation space 12 to form an annular bump 112, that is, a first end surface 117 of the first side wall 11 extends toward the second base 20 to form an annular bump 112, and the annular bump 112 and the first end surface 117 together form an inner accommodation groove 111. An outer surface 210 of the second side wall 21 has an outer accommodation groove 211 surrounding the second accommodation space 22 to form an annular protrusion 212, that is, a second end surface 217 of the second side wall 21 (i.e., the end of the second side wall 21 away from the second bottom wall 25) extends toward the first base 10 to form an annular protrusion 212, and the annular protrusion 212 and the second end surface 217 together form an outer accommodation groove 211. The annular bump 112 extends into the outer accommodation groove 211, and the annular protrusion 212 is accommodated in the inner accommodation groove 111. The annular bump 112 is spaced from the second end surface 217 to form a gap 102. The annular bump 112 is spaced from the annular protrusion 212 to form a gap 103. The gap 102 is connected to the gap 103 to form a bent channel 104. In some embodiments, the first side wall 11 forms the inner accommodation groove 111 and the annular protrusion 212 is accommodated in the inner accommodation groove 111, which increases the number of bending times of the channel 104, thereby further increasing a difficulty of dust, moisture, etc. entering the accommodation cavity 101 along the gap 102, and hence further improving a capability of dustproof of the driving device 100.

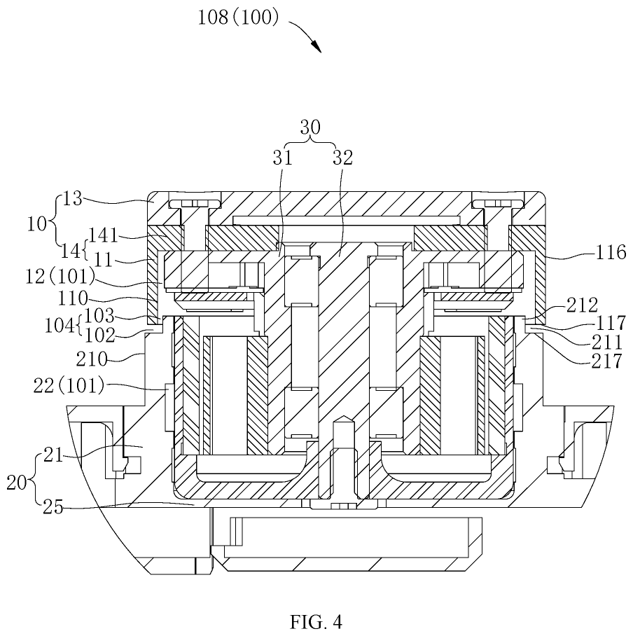

In some embodiments, as shown in FIG. 4 and FIG. 5, the outer surface 210 of the second side wall 21 and the outer surface 116 of the first side wall 11 are aligned. Specifically, the shape and size of the outer surface 210 of the second side wall 21 are consistent with the shape and size of the outer surface 116 of the first side wall 11. In some embodiments, the outer surface 210 of the second side wall 21 is aligned with the outer surface 116 of the first side wall 11 to achieve a better-looking appearance of the driving device 100 and reduce a wind guiding effect of the gap 102, thereby further increasing a difficulty of dust, moisture, etc., entering the accommodation cavity 101 along the gap 102, and hence further improving a capability of dustproof of the driving device 100.

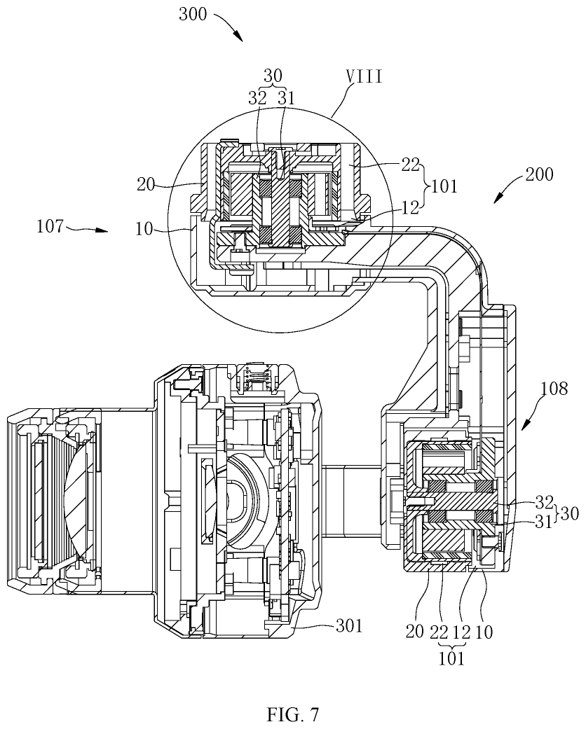

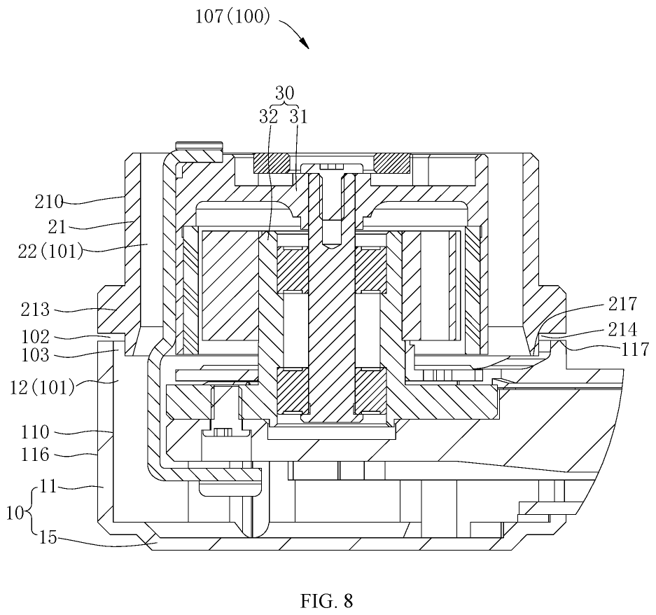

In some embodiments, as shown in FIG. 7 and FIG. 8, the outer surface 210 of the second side wall 21 extends outward (i.e., away from the center of the second accommodation space 22) to form an annular projection 213. The annular projection 213 and the outer surface 210 together form a mounting groove 214, and the first side wall 11 extends into the mounting groove 214. Specifically, the annular projection 213 is formed between two end surfaces of the second side wall 21 so that the annular projection 213 and the outer surface 210 together form the mounting groove 214. The end surface of the annular projection 213 is spaced from the first end surface 117 of the first side wall 11 to form a gap 102. The outer surface 210 of the second side wall 21 is spaced from the inner surface 110 of the first side wall 11 to form a gap 103. The second side wall 21 separates the gap 102 from the accommodation cavity 101. The gap 102 is connected to the gap 103 to form a bent channel 104. The annular protrusion 212 separates the gap 102 from the accommodation cavity 101, thereby increasing a difficulty of dust, moisture, etc. entering the accommodation cavity 101 along the gap 102, and hence improving a capability of dustproof of the driving device 100 and ensuring a normal rotation of the driving device 100.

In some embodiments, as shown in FIG. 8, the outer surface 116 of the first side wall 11 and an outer surface of the annular projection 213 are aligned. Specifically, the shape and size of the outer surface of the annular projection 213 are consistent with the shape and size of the outer surface 116 of the first side wall 11. In some embodiments, the outer surface 116 of the first side wall 11 is aligned with the outer surface of the annular projection 213 to achieve a better-looking appearance of the driving device 100 and reduce a wind guiding effect of the gap 102, thereby further increasing a difficulty of dust, moisture, etc. entering the accommodation cavity 101 along the gap 102, and hence further improving a capability of dustproof of the driving device 100.

In some embodiments, as shown in FIG. 5, the first base 10 includes a first bottom wall 15 and a first side wall 11 extending from the first bottom wall 15. The first bottom wall 15 and the first side wall 11 together form a first accommodation space 12. The first bottom wall 15 may enclose one end of the first accommodation space 12, or the first bottom wall 15 may be provided with a through hole connecting with the first accommodation space 12. The second accommodation space 22 is a through hole penetrating the second base 20, that is, the second base 20 includes the second side wall 21 but not the second bottom wall 25. A stator 31 is disposed at the second base 20 and encloses one end of the second accommodation space 22 (i.e., the end away from the first end surface 117). A rotor 32 is disposed at the first base 10, and the rotor 32 can be rotatably disposed at the stator 31. In some embodiments, the gimbal 200 is a three-axis gimbal, and the driving device 100 can be a yaw driving device provided at a yaw axis, a roll driving device provided at a roll axis, or a pitch driving device provided at a pitch axis. In some embodiments, the driving device 100 is a pitch driving device, in which case the first base 10 is a casing of an arm of the pitch axis, and the second base 20 is a casing of an arm of the roll axis.

In some embodiments, as shown in FIG. 8, the first base 10 includes a first bottom wall 15 and a first side wall 11 extending from the first bottom wall 15. The first bottom wall 15 and the first side wall 11 together form a first accommodation space 12. The second base 20 includes a second bottom wall 25 and a second side wall 21 extending from the second bottom wall 25. The second bottom wall 25 and the second side wall 21 together form a second accommodation space 22. The first bottom wall 15 may enclose one end of the first accommodation space 12, or the first bottom wall 15 may be provided with a through hole connecting with the first accommodation space 12. The second bottom wall 25 may enclose one end of the second accommodation space 22, or the second bottom wall 25 may be provided with a through hole connecting with the second accommodation space 22. A stator 31 is disposed at the second bottom wall 25. A rotor 32 is disposed at the first base 10, and the rotor 32 can be rotatably disposed at the stator 31. In some embodiments, the gimbal 200 is a three-axis gimbal, and the driving device 100 can be a yaw driving device provided at a yaw axis, a roll driving device provided at a roll axis, or a pitch driving device provided at a pitch axis. In some embodiments, the driving device 100 is a yaw driving device, in which case the first base 10 is a casing of an arm of the yaw axis, and the second base 20 is a casing of an adapter of the gimbal 200.

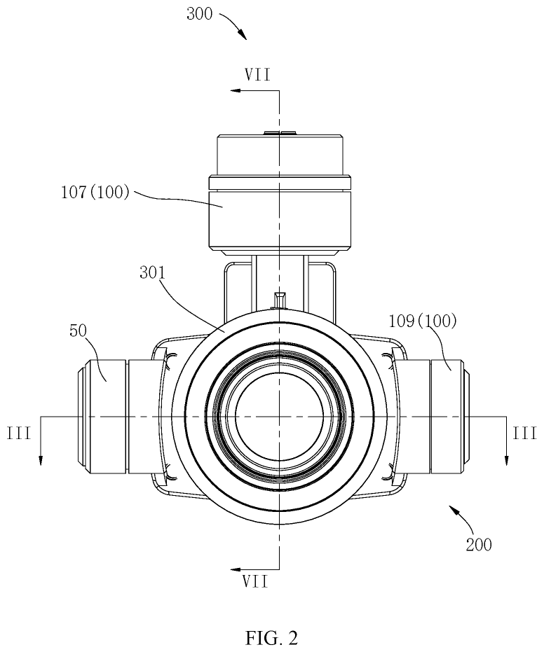

As shown in FIG. 1 and FIG. 2, a gimbal 200 includes a driving device 100 according to any of embodiments described above. The gimbal 200 may include one, two, three, or any number of the driving devices 100.

In some embodiments, part of the structure of the second side wall 21 of the driving device 100 extends into the first accommodation space 12 and separates the gap 102 from the accommodation cavity 101, thereby increasing a difficulty of dust, moisture, etc. entering the accommodation cavity 101 along the gap 102, and hence improving a protective capability, e.g., dustproof and waterproof, etc., of the driving device 100 and ensuring a normal rotation of the driving device 100.

In some embodiments, as shown in FIG. 1 and FIG. 2, the gimbal 200 is a three-axis gimbal that includes a yaw axis, a roll axis, a pitch axis, and three driving devices 100 including a first driving device 107, a second driving device 108, and a third driving device 109. The first driving device 107 is configured to drive the yaw axis to rotate and may be the yaw driving device 100 described above. The second driving device 108 is configured to drive the roll axis to rotate and may be the roll driving device 100 described above. The third driving device 109 is configured to drive the pitch axis to rotate and may be the pitch driving device 100 described above. It should be noted that the first driving device 107, the second driving device 108, and the third driving device 109 may all be the driving device 100 in any of the above described embodiments. For example, the first driving device 107, the second driving device 108, and the third driving device 109 are all the above described yaw driving device 100; or the first driving device 107, the second driving device 108, and the third driving device 109 are all the above described roll driving device 100; or the first driving device 107, the second driving device 108, and the third driving device 109 are all the above described pitch driving device 100; or the first driving device 107 and the second driving device 108 are the above described yaw driving device 100, and the third driving device 109 is the above described roll driving device 100; or the first driving device 107 and the second driving device 108 are the above described roll driving device 100, and the third driving device 109 is the above described pitch driving device 100, etc. By analogy, they all fall within the scope of the present disclosure, and will not be listed here. In some embodiments, the first driving device 107 is the yaw driving device, the second driving device 108 is the roll driving device, and the third driving device 109 is the pitch driving device.

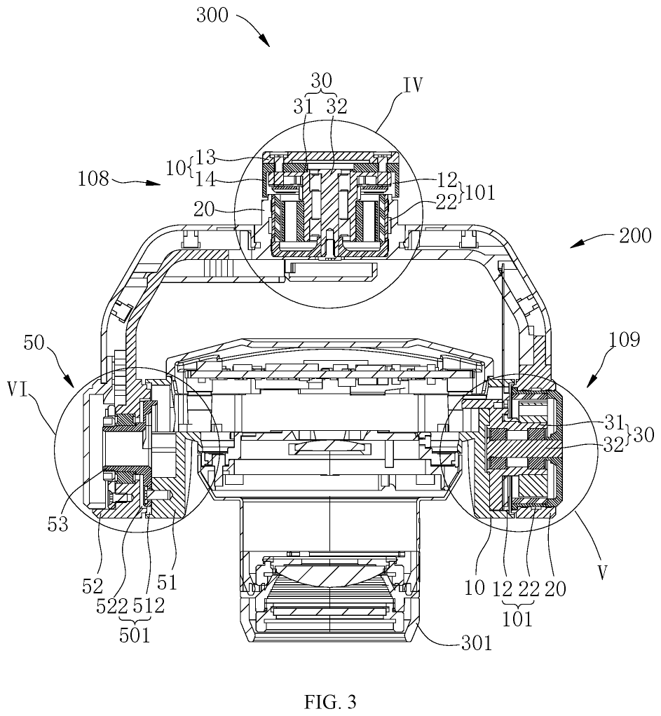

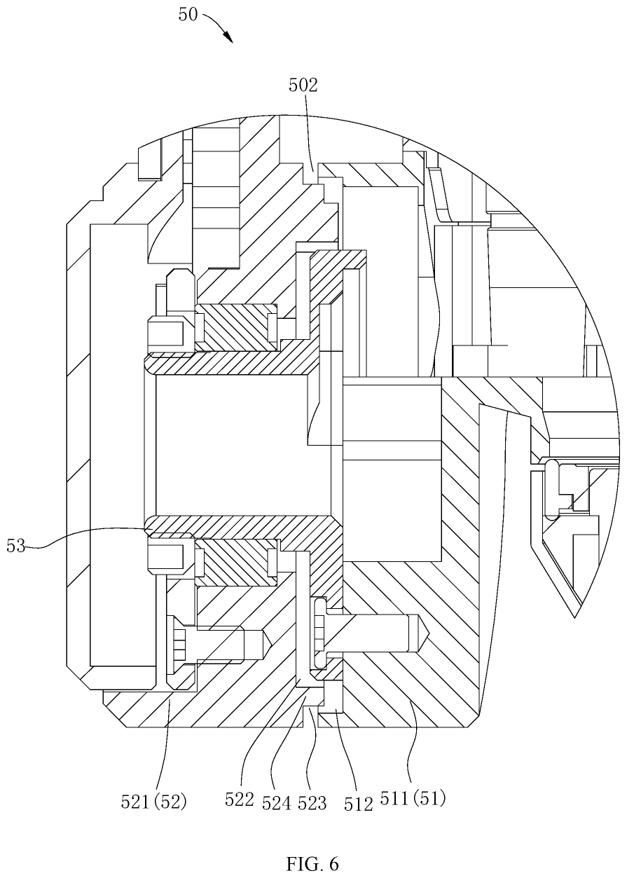

In some embodiments, as shown in FIG. 3 and FIG. 6, the gimbal 200 further includes a pitch rotation device 50 that cooperates with the third driving device 109. The pitch rotation device 50 includes a first cover 51, a second cover 52, and a rotation assembly 53. The first cover 51 includes a first cover side wall 511 that encloses a first cavity space 512. The second cover 52 faces the third driving device 109. The second cover 52 includes a second cover side wall 521 that encloses a second cavity space 522. The first cover 51 and the second cover 52 are combined, and the first cavity space 512 and the second cavity space 522 together form an accommodation cavity space 501. The first cover side wall 511 and the second cover side wall 521 are disposed opposite to each other and form an interval 502 that allows a relative rotation. The interval 502 is in communication with the accommodation cavity space 501. Part of the structure of the second cover side wall 521 extends into the first accommodation space 512 and separates the interval 502 from the accommodation cavity space 501. The rotation assembly 53 is disposed at the first cover 51 and the second cover 52, and is accommodated in the accommodation cavity space 501. The rotation assembly 53 can rotate relative to the first cover 51.

Specifically, the rotation assembly 53 is fixed at the second cover 52 and can be rotatably disposed at the first cover 51. The rotation direction of the pitch rotation device 50 is consistent with the rotation direction of the third driving device 109, and a shaft of the pitch rotation device 50 and a shaft of the third driving device 109 are aligned on a same straight line. When an imaging device 301 is provided at the pitch rotation device 50 and the third driving device 109, it is convenient for the third driving device 109 to drive the imaging device 301 to rotate. In some embodiments, the rotation assembly 53 is fixed at the first cover 51 and can be rotatably disposed at the second cover 52. In some embodiments, the rotation assembly 53 can be a part of the second cover 52 and can be rotatably disposed at the first cover 51, or the rotation assembly 53 can be a part of the first cover 51 and can be rotatably disposed at the second cover 52. In some embodiments, the rotation assembly 53 includes a first rotation component and a second rotation component that are rotatably connected to each other. The first rotation component is fixed with the first cover 51, and the second rotation component is fixed with the second cover 52.

In some embodiments, part of the structure of the second cover side wall 521 of the pitch rotation device 50 extends into the first accommodation space 512 and separates the interval 502 from the accommodation cavity space 501, thereby increasing a difficulty of dust, moisture, etc. entering the accommodation cavity space 501 along the gap 102, and hence improving a capability of dustproof of the pitch rotation device 50.

In some embodiments, as shown in FIG. 5, an outer surface of the second cover side wall 521 has a cover mounting groove 523 surrounding the second cavity space 522 to form an annular cover protrusion 524. The annular cover protrusion 524 extends into the first cavity space 512 and separates the interval 502 from the accommodation cavity space 501. The first cover side wall 511 extends into the cover mounting groove 523.

As shown in FIG. 1 and FIG. 2, a photographing device 300 includes a gimbal 200 according to any of embodiments described above and an imaging device 301. The imaging device 301 is disposed at the gimbal 200, so that the driving device 100 of the gimbal 200 can drive the imaging device 301 to rotate.

In some embodiments, part of the structure of the second side wall 21 of the driving device 100 of the photographing device 300 extends into the first accommodation space 12 and separates the gap 102 from the accommodation cavity 101, thereby increasing a difficulty of dust, moisture, etc. entering the accommodation cavity 101 along the gap 102, and hence improving a protective capability of dustproof of the driving device 100 and ensuring a normal rotation of the driving device 100 and a normal photographing of the photographing device 300.

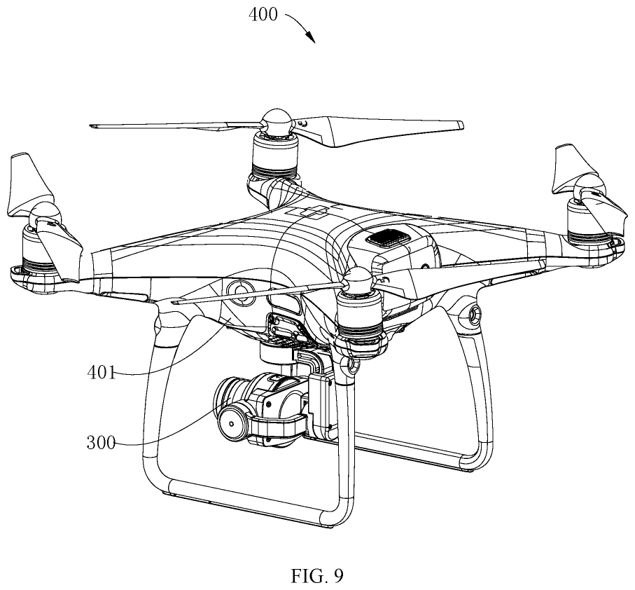

As shown in FIG. 9, an unmanned aerial vehicle 400 includes a body 401 and a photographing device 300 in the above described embodiment. The photographing device 300 is disposed at the body 401.

In some embodiments, part of the structure of the second side wall 21 of the driving device 100 of the unmanned aerial vehicle 400 extends into the first accommodation space 12 and separates the gap 102 from the accommodation cavity 101, thereby increasing a difficulty of dust, moisture, etc. entering the accommodation cavity 101 along the gap 102, and hence improving a protective capability of dustproof of the driving device 100 and ensuring a normal rotation of the driving device 100 and the unmanned aerial vehicle 400 can normally perform an aerial photography task.

The description of “some embodiments,” “one embodiment,” “an embodiment,” “example embodiment,” “example,” “specific example,” or “some example,” means that specific features, structures, materials, or characteristics described in conjunction with the embodiments or examples are included in at least one embodiment or example of the present disclosure. In this specification, the schematic expressions of the above terms do not necessarily refer to the same embodiment or example. The specific features, structures, materials, or characteristics described may be combined in any suitable manner in one or more embodiments or examples.

In addition, terms “first” and “second” are only for descriptive purposes and should not be understood as indicating or implying a relative importance or implicitly indicating the number of a technical feature indicated. A feature defined as “first” and “second” may explicitly or implicitly include one or more of the feature. In the description of the present disclosure, the term “plurality” refers to two or more, e.g., two, three, etc., unless otherwise specifically defined.

Although the embodiments of the present disclosure have been shown and described above, it can be understood that the above embodiments are exemplary and should not be construed as limitations on the present disclosure. Those skilled in the art can change, modify, substitute, and transform the above embodiments within the scope of the present disclosure.

What is claimed is:

1. A device for driving a gimbal comprising:
a first base including a first side wall enclosing a first accommodation space;
a second base including a second side wall enclosing a second accommodation space, the first accommodation space and the second accommodation space forming an accommodation cavity, the first side wall and the second side wall being disposed opposite to each other and forming a gap in communication with the accommodation cavity, and a part of the second side wall extending into the first accommodation space and separating the gap from the accommodation cavity; and
a driver disposed at the first base and the second base, accommodated in the accommodation cavity, and configured to drive the second base to rotate relative to the first base.

2. The device of claim 1, wherein an outer surface of the second side wall has an outer accommodation groove surrounding the second accommodation space to form an annular protrusion, the annular protrusion extending into the first accommodation space and separating the gap from the accommodation cavity, and the first side wall extending into the outer accommodation groove.

3. The device of claim 2, wherein an inner surface of the first side wall has an inner accommodation groove surrounding the first accommodation space to form an annular bump, the annular bump extending into the outer accommodation groove, and the annular protrusion being accommodated in the inner accommodation groove.

4. The device of claim 1, wherein an outer surface of the second side wall and an outer surface of the first side wall are aligned with each other.

5. The device of claim 1, wherein an outer surface of the second side wall extends outward to form an annular projection, the annular projection and the outer surface of the second side wall together forming a mounting groove, and the first side wall extending into the mounting groove.

6. The device of claim 5, wherein an outer surface of the first side wall and an outer surface of the annular projection are aligned with each other.

7. The device of claim 1, wherein:
the first base includes a cover and a connection base, the connection base including a first bottom wall and the first side wall extending from the first bottom wall, and the cover being fixed at a side of the first bottom wall that is opposite to the first side wall; and
the second base includes a second bottom wall and the second side wall extending from the second bottom wall, the second bottom wall and the second side wall together forming the second accommodation space.

8. The device of claim 7, wherein the driver includes:
a stator disposed at the connection base; and
a rotor disposed at the second base and configured to rotate relative to the stator.

9. The device of claim 1, wherein:
the first base includes a first bottom wall and the first side wall extending from the first bottom wall, the first bottom wall and the first side wall together forming the first accommodation space; and
the second accommodation space includes a through hole penetrating the second base.

10. The device of claim 9, wherein the driver includes:
a stator disposed at the second base and enclosing one end of the second accommodation space; and
a rotor disposed at the first base and configured to rotate relative to the stator.

11. The device of claim 1, wherein:
the first base includes a first bottom wall and the first side wall extending from the first bottom wall, the first bottom wall and the first side wall together forming the first accommodation space; and
the second base includes a second bottom wall and the second side wall extending from the second bottom wall, the second bottom wall and the second side wall together forming the second accommodation space.

12. The device of claim 11, wherein the driver includes:
a stator disposed at the second base; and
a rotor disposed at the first base and configured to rotate relative to the stator.

13. The device of claim 1, wherein:
the first base includes a casing of an arm of a yaw axis of the gimbal; and
the second base includes a casing of an adapter of the gimbal.

14. The device of claim 1, wherein:
the first base includes a casing of an arm of a yaw axis of the gimbal; and
the second base includes a casing of an arm of a roll axis of the gimbal.

15. The device of claim 1, wherein:
the first base includes a casing of an arm of a pitch axis of the gimbal; and
the second base includes a casing of an arm of a roll axis of the gimbal.

16. A gimbal comprising:
a driving device including:
a first base including a first side wall enclosing a first accommodation space;
a second base including a second side wall enclosing a second accommodation space, the first accommodation space and the second accommodation space forming an accommodation cavity, the first side wall and the second side wall being disposed opposite to each other and forming a gap in communication with the accommodation cavity, and a part of the second side wall extending into the first accommodation space and separating the gap from the accommodation cavity; and
a driver disposed at the first base and the second base, accommodated in the accommodation cavity, and configured to drive the second base to rotate relative to the first base.

17. The gimbal of claim 16,
wherein the driving device is a first driving device configured to effect a rotation about a yaw axis of the gimbal;
the gimbal further comprising:
a second driving device configured to effect a rotation about a roll axis of the gimbal; and
a third driving device configured to effect a rotation about a pitch axis of the gimbal.

18. The gimbal of claim 17, further comprising:
a pitch rotation device cooperating with the third driving device and including:
a first cover including a first cover side wall enclosing a first cavity space;
a second cover connected to the second driving device and facing the third driving device, the second cover including a second cover side wall enclosing a second cavity space, the first cavity space and the second cavity space together forming an accommodation cavity space, the first cover side wall and the second cover side wall being disposed opposite to each other and forming an interval in communication with the accommodation cavity space, and a part of the second cover side wall extending into the first cavity space and separating the gap from the accommodation cavity; and
a rotation assembly disposed at the first cover and the second cover and accommodated in the accommodation cavity space, and configured to rotate relative to the first cover or the second cover.

19. A photographing device comprising:
a gimbal including:
a driving device including:
a first base including a first side wall enclosing a first accommodation space;
a second base including a second side wall enclosing a second accommodation space, the first accommodation space and the second accommodation space forming an accommodation cavity, the first side wall and the second side wall being disposed opposite to each other and forming a gap in communication with the accommodation cavity, and a part of the second side wall extending into the first accommodation space and separating the gap from the accommodation cavity; and
a driver disposed at the first base and the second base, accommodated in the accommodation cavity, and configured to drive the second base to rotate relative to the first base; and
an imaging device disposed at the gimbal.

20. An unmanned aerial vehicle comprising:
a body; and
the photographing device of claim 19 disposed at the body.
